(19) United States
(12) Patent Application Publication
(10) Pub. No.: US 2026/0180408 A1
(43) Pub. Date: Jun. 25, 2026

(54) METHODS AND SYSTEMS FOR A ROTOR SENSOR

(71) Applicant: DANA TM4 INC., Boucherville (CA)

(72) Inventors: Jordi VAN DAMME, Eke (BE); Joachim DRUANT, Houthulst (BE); Benoit BLANCHARD ST-JACQUES, Boucherville (CA); Gabriel GUILMAIN, McMasterville (CA); Alain ST-JACQUES, St-Bruno-de-Montarville (CA)

(21) Appl. No.: 18/990,736

(22) Filed: Dec. 20, 2024

(51) Int. Cl. H02K 11/042; H02K 11/27

(52) U.S. Cl. CPC H02K 11/042; H02K 11/27

(57) ABSTRACT

Systems and methods are provided for a transformer of an electric machine. In one example, an externally excited electric machine includes a sensor mounted on a stationary ferromagnetic core of a transformer. a solenoid coil coupled to a rotating ferromagnetic core of the transformer, and a controller with instructions stored on non-transitory memory thereof that when executed enable the controller to adjust a switching frequency of an inverter based on feedback from the sensor.

### TECHNICAL FIELD

The present description relates generally to a sensor of a rotor of an electric machine.

### BACKGROUND AND SUMMARY

For ecological and economic reasons there is a desire to create motor designs without rare-earth magnets. To keep the advantages of the existing synchronous permanent magnet (PM) machines an alternative solution is the externally excited synchronous motor (EESM). Instead of rare-earth permanent magnets providing the magnetic field in the rotor an electromagnet is used. An EESM requires power transfer to the rotor, this can be done through various means such as carbon brushes or a rotating transformer. Rotating transformers have the advantage to be maintenance free and eliminate friction losses however rotor current sensing becomes more challenging as there is a galvanic isolation between the rotor and stator and therefore rotor current information from a current sensor on the rotor can no longer be transmitted to the stator via a galvanic connection. Information on the rotor current is used for torque control purposes.

Thus, a demand for an improved sensor is present. In one example, an externally excited electric machine including a sensor mounted on a stationary ferromagnetic core of a transformer, a solenoid coil coupled to a rotating ferromagnetic core of the transformer, and a controller with instructions stored on non-transitory memory thereof that when executed enable the controller to adjust a frequency of an inverter based on feedback from the sensor.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE FIGURES

The above, as well as other advantages of the present disclosure, will become readily apparent to those skilled in the art from the following detailed description when considered in light of the accompanying drawings in which:

FIG. 1 is a schematic depiction of an example vehicle, according to an embodiment of the present disclosure; and

FIG. 2A is an embodiment of an electric machine comprising a sensor.

FIG. 2B is an embodiment of components of the electric machine communicating with one another.

FIG. 3 is a method for adjusting a frequency of an inverter of the electric machine.

FIG. 4 is a method for adjusting the frequency of the inverter based on a load of the electric machine.

FIG. 5 is a flow chart illustrating a change in the switching frequency generated by inverter when a sudden torque step occurs.

FIG. 6 is an exemplary electric machine map where rotor field current, torque, vs. speed are plotted.

FIG. 7 is a graph showing jitters applied to the DCAC converter's switching frequency.

FIG. 8 is a graph showing higher harmonics applied to a signal for active rectifier control.

### DETAILED DESCRIPTION

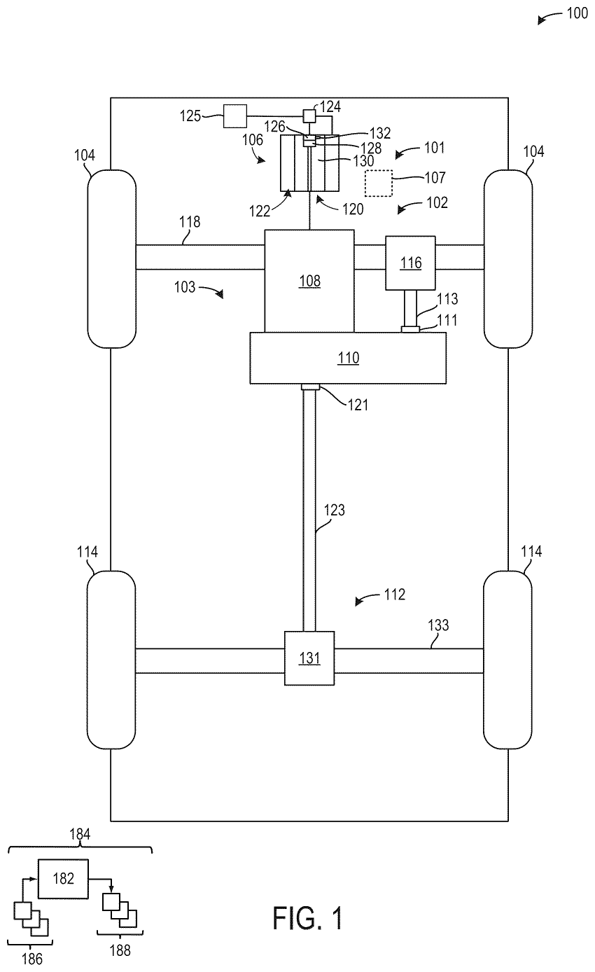

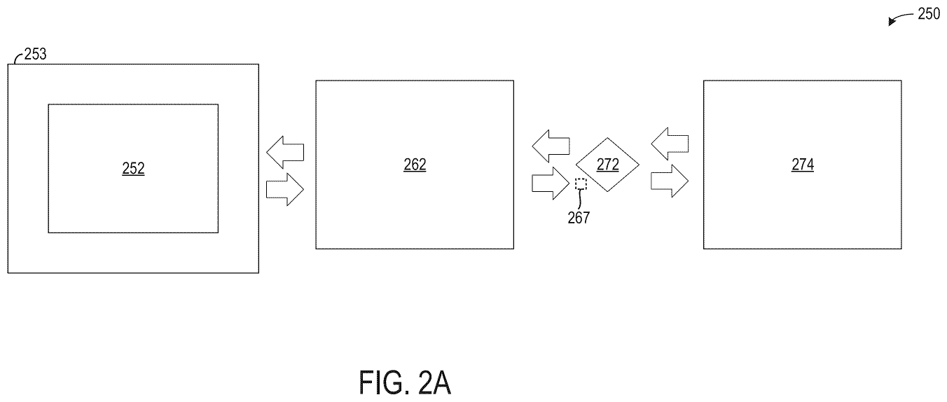

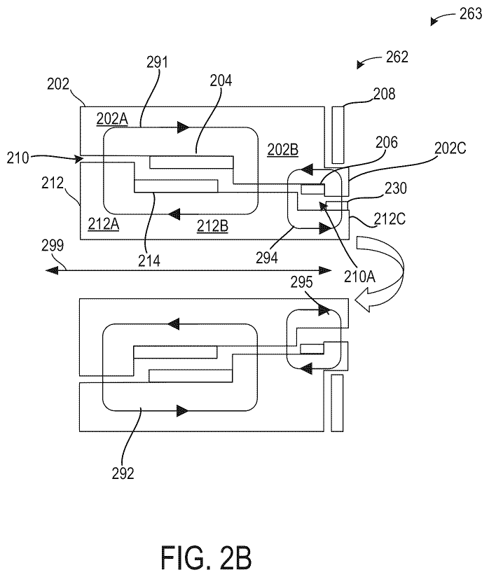

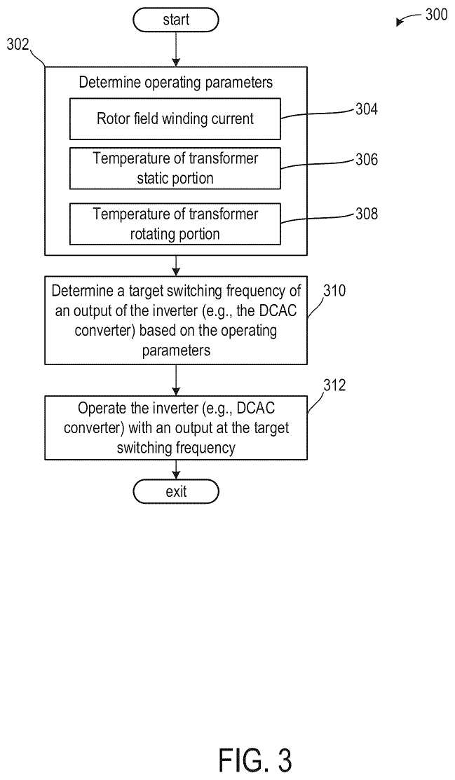

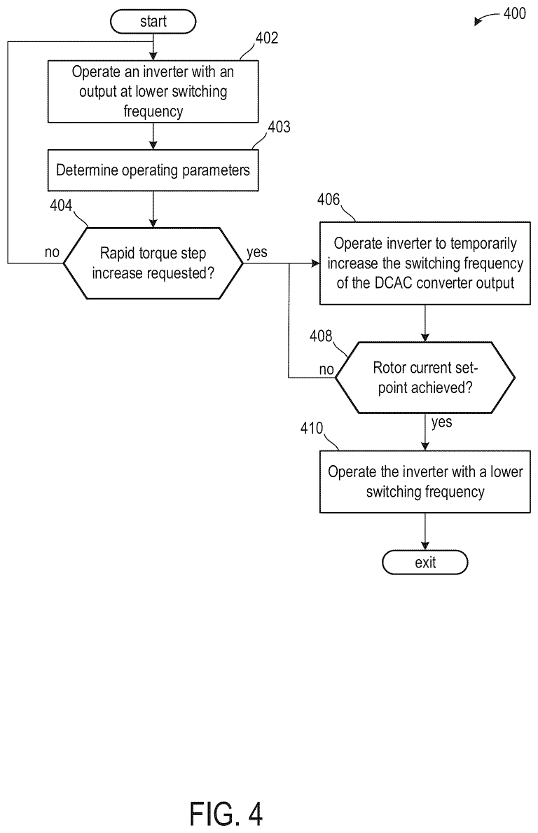

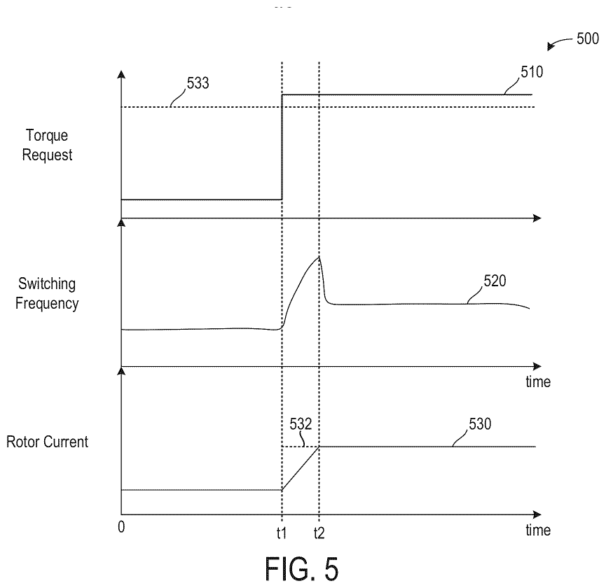

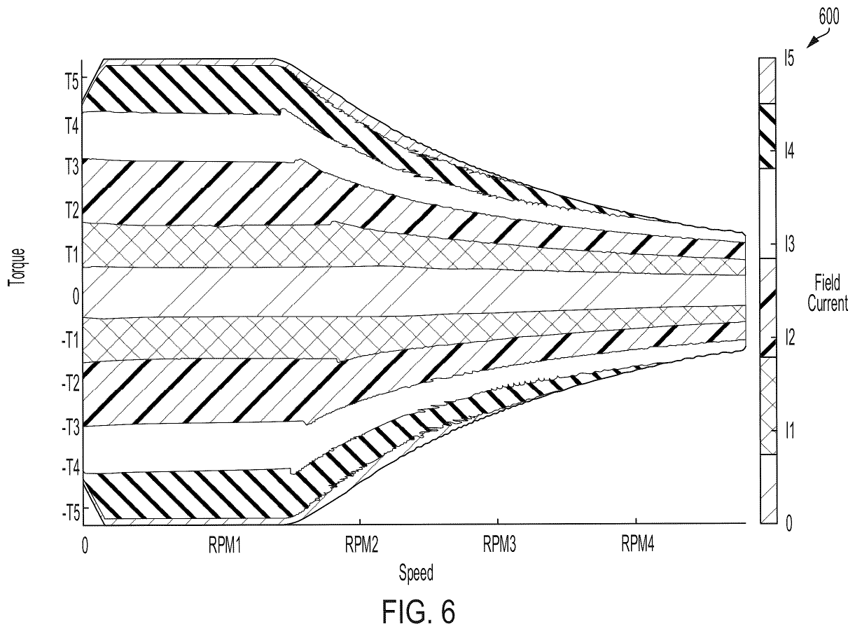

The following description relates to an electric machine. In one example, the electric machine may be arranged in a powertrain of vehicle, as shown in FIG. 1. However, the electric machine may be included in other suitable systems, in alternate examples. FIG. 2A illustrates exemplary components in an electric machine including a DCAC converter, a transformer, a rectifier, and rotor windings. FIG. 2B is an embodiment of the transformer, depicted in FIG. 2A, with a hall effect sensor. FIG. 3 is a method for adjusting a frequency of an inverter of the electric machine. FIG. 4 is a method for adjusting the switching frequency of the inverter based on a load of the electric machine. FIG. 5 is a timing diagram of an inverter control technique where a switching frequency is temporarily increased in response to a rapid step up in requested torque. FIG. 6 is an electric machine operating map. FIG. 6 shows a control strategy for an electric machine where jitters are applied to a DCAC converter's switching frequency. FIG. 7 shows a control strategy where higher harmonics are applied to a signal for active rectifier control.

FIGS. 1-2B show example configurations with relative positioning of the various components. If shown directly contacting each other, or directly coupled, then such elements may be referred to as directly contacting or directly coupled, respectively, at least in one example. Similarly, elements shown contiguous or adjacent to one another may be contiguous or adjacent to each other, respectively, at least in one example. As an example, components laying in face-sharing contact with each other may be referred to as in face-sharing contact. As another example, elements positioned apart from each other with only a space there-between and no other components may be referred to as such, in at least one example. As yet another example, elements shown above/below one another, at opposite sides to one another, or to the left/right of one another may be referred to as such, relative to one another. Further, as shown in the figures, a topmost element or point of element may be referred to as a “top” of the component and a bottommost element or point of the element may be referred to as a “bottom” of the component, in at least one example. As used herein, top/bottom, upper/lower, above/below, may be relative to a vertical axis of the figures and used to describe positioning of elements of the figures relative to one another. As such, elements shown above other elements are positioned vertically above the other elements, in one example. As yet another example, shapes of the elements depicted within the figures may be referred to as having those shapes (e.g., such as being circular, straight, planar, curved, rounded, chamfered, angled, or the like). Further, elements shown intersecting one another may be referred to as intersecting elements or intersecting one another, in at least one example. Further still, an element shown within another element or shown outside of another element may be referred as such, in one example. It will be appreciated that one or more components referred to as being “substantially similar and/or identical” differ from one another according to manufacturing tolerances (e.g., within 1-5% deviation).

Turning now to FIG. 1, a vehicle 100 is shown comprising a powertrain 101 with a drivetrain 103. The powertrain comprises an electric machine 106 and a transmission 108. The electric machine may specifically be a traction motor. The transmission 108 may be any type of transmission, such as a manual transmission, an automatic transmission, or a continuously variable transmission. The transmission 108 receives the rotary power produced by the electric machine 106 as an input and outputs rotary power to the drivetrain 103 in accordance with a selected gear or setting.

The electric machine 106 includes a rotor 120 and a stator 122. To elaborate, the electric machine 106 is an externally excited synchronous motor (EESM), in the illustrated example. In such an example, an inverter 124 (e.g., a power electronic module) is electrically coupled to both the rotor 120 and the stator 122. It will be understood that the inverter may include higher power circuitry for stator supply and excitation circuitry (e.g., a direct current to alternative current (DCAC) converter) for rotor supply. The inverter 124 is electrically coupled to an energy storage device 125 (e.g., one or more batteries, capacitors, combinations thereof, and the like).

The rotor 120 may include a rotating transformer 126 that is electrically coupled to a rotating rectifier 128 (e.g., a passive or an active rectifier), and rotor windings 130. A hall-effect current sensor 132 or other suitable non-contact sensor may be coupled to the transformer 126. To elaborate, the hall-effect current sensor 132 may be coupled to a stationary yoke of the transformer, as discussed in greater detail herein with regard to FIG. 2B. The signal from the hall-effect current sensor 132 (which is indicative of rotor current) may be used to control the duty cycle and frequency of the output of the DCAC converter in the inverter 124. To elaborate, the duty cycle and frequency of the DCAC converter may be dynamically adjusted based on target rotor field winding current as well as the temperature of the rotating portion and the static portion (e.g., yokes) of the transformer, as discussed in greater detail herein with regard to FIG. 3.

In a hybrid vehicle example, the powertrain 101 shown in FIG. 1 may further include an internal combustion engine 107. The internal combustion engine 107 may be configured to recharge the energy storage device 125 and/or provide mechanical power to the transmission and/or directly to a drive axle. For instance, the electric machine 106 may provide motive power to one drive axle while internal combustion engine may provide motive power to another drive axle, although numerous powertrain architectures are possible.

The electric machine 106 may be coupled to the energy storage device 125 by way of the inverter 124, as discussed above. A charge of the energy storage device may be monitored via a sensor or estimated based on vehicle operating conditions. In one example, electric machine 106 may be configured to replenish a charge of the energy storage device during a generator operation.

The vehicle 100 may be a light, medium, or heavy duty vehicle, a passenger vehicle, a commercial vehicle, an off-highway vehicle, and a sport utility vehicle. Additionally or alternatively, the vehicle 100 and/or one or more of its components may be in industrial, locomotive, military, agricultural, and aerospace applications.

In some examples, such as shown in FIG. 1, the drivetrain 103 includes a first axle assembly 102 and a second axle assembly 112. The first axle assembly 102 may be configured to drive a first set of wheels 104, and the second axle assembly 112 may be configured to drive a second set of wheels 114. In one example, the first axle assembly 102 is arranged near a front of the vehicle 100 and thereby comprises a front axle, and the second axle assembly 112 is arranged near a rear of the vehicle 100 and thereby comprises a rear axle. The drivetrain 103 is shown in a four-wheel drive configuration, although other configurations are possible. For example, the drivetrain 103 may include a front-wheel drive, a rear-wheel drive, or an all-wheel drive configuration. Further, the drivetrain 103 may include one or more tandem axle assemblies. As such, the drivetrain 103 may have other configurations without departing from the scope of this disclosure, and the configuration shown in FIG. 1 is provided for illustration, not limitation. Further, the vehicle 100 may include additional wheels that are not coupled to the drivetrain 103.

In some four-wheel drive configurations, such as shown in FIG. 1, the drivetrain 103 includes a transfer case 110 configured to receive rotary power output by the transmission 108. A first driveshaft 113 is drivingly coupled to a first output 111 of the transfer case 110, while a second driveshaft 123 is drivingly coupled to a second output 121 of the transfer case 110. The first driveshaft 113 (e.g., a front driveshaft) transmits rotary power from the transfer case 110 to a first differential 116 of the first axle assembly 102 to drive the first set of wheels 104, while the second driveshaft 123 (e.g., a rear driveshaft) transmits the rotary power from the transfer case 110 to a second differential 131 of the second axle assembly 112 to drive the second set of wheels 114. For example, the first differential 116 is drivingly coupled to a first set of axle shafts 118 coupled to the first set of wheels 104, and the second differential 131 is drivingly coupled to a second set of axle shafts 133 coupled to the second set of wheels 114. It may be appreciated that each of the first set of axle shafts 118 and the second set of axle shafts 133 may be positioned in a housing. However, a variety of powertrain architectures are possible. For instance, the electric machine 106 may be included in an electric axle.

Additionally or alternatively, the vehicle 100 may be a hybrid vehicle including both the engine and the electric machine each configured to supply power to one or more of the first axle assembly 102 and the second axle assembly 112. For example, one or both of the first axle assembly 102 and the second axle assembly 112 may be driven via power originating from the engine in a first operating mode where the electric machine is not operated to provide power (e.g., an engine-only mode), via power originating from the electric machine in a second operating mode where the engine is not operated to provide power (e.g., an electric-only mode), and via power originating from both the engine and the electric machine in a third operating mode (e.g., an electric assist mode). As another example, one or both of the first axle assembly 102 and the second axle assembly 112 may be an electric axle assembly that is configured to be driven by an integrated electric machine.

The vehicle 100 may further include a control system 184. Control system 184 is shown comprising a controller 182 receiving information from a plurality of sensors 186 and sending control signals to a plurality of actuators 188. The controller 182 may receive input data from the various sensors, process the input data, and trigger the actuators in response to the processed input data based on instruction or code programmed therein corresponding to one or more routines. The plurality of sensors 186 may include speed sensors, temperature sensors, humidity sensors, location sensors, accelerometers, and the like. The plurality of actuators 188 may be actuators of one more valves, motors, and other devices.

Turning now to FIG. 2A, it shows an embodiment of an EESM 250 that includes a direct current (DCAC) converter 252 in an inverter 253. The DCAC converter 252 may use an H-bridge circuit, in one example, or a half bridge circuit with capacitors, in another example. It will be appreciated that the EESM 250 serves as an example of the electric machine 106, shown in FIG. 1. Therefore, at least a portion of the components from the EESM 250 may be included in the electric machine 106 and/or vice versa.

The DCAC converter 252 is in electric communication with a transformer 262, in the illustrated example. A detailed example of the transformer 262 is shown in FIG. 2B and discussed in greater detail herein.

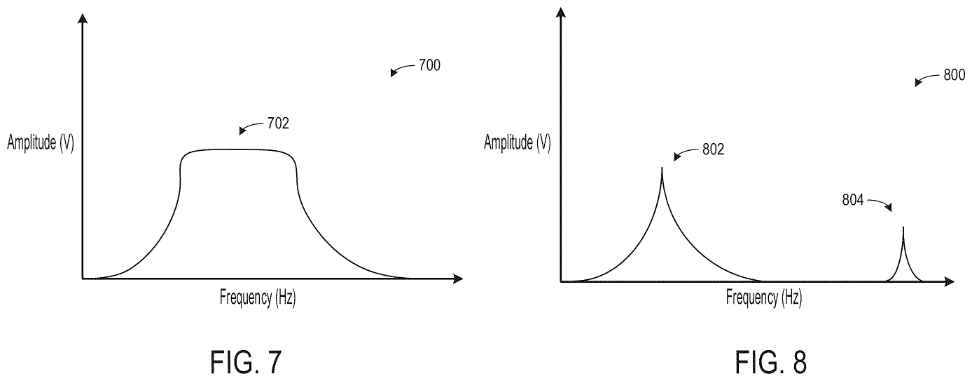

The transformer 262 is in electric communication with a rotating rectifier 272 in the illustrated example. The rectifier 272 is configured to converter AC current to DC current. The rectifier 272 may be a passive rectifier or an active rectifier, in different example. In the active rectifier example, the active rectifier may be configured to superimpose a signal on the fundamental power that is transferred from the DCAC converter 252 to the transformer 262 and ultimately rotor windings 274, as discussed in greater detail herein with regard to FIGS. 7-8. In this way, the active rectifier is able to provide communication capabilities to the rotor. For instance, a higher order harmonic (for active rectifier control) may be superimposed onto a pulse-width modulation (PWM) signal sent from the DCAC converter 252 to the transformer 262. Thus, the PWM signal with the higher order harmonic is transferred from a stationary part of the transformer to a rotating part of the transformer. Then a filter 267 may be used to demodulate the encoded signal for control of the active rectifier that is in electronic communication with the transformer. Alternatively an additional device can be added between the rotating transformer and a passive rectifier that may function similarly to the active rectifier control strategy described above.

The rectifier 272 converts the AC current of the rotating part of the transformer to a DC current which then flows through the rotor of the EESM 250. FIG. 2B shows a more detailed illustration of the rotor architecture which is discussed in greater detail below.

In some examples, additionally or alternatively, a communication device may be included between the transformer 262 and the rectifier 272. The communication device may be configured to operate similarly to the active rectifier described above. In this way, the EESM may include a device configured to add a filter to an initial signal for communication. The EESM may thus include a communication link between the inverter 253 and a controller (e.g., controller 182 of FIG. 1), wherein the communication link may transmit temperature, current, and other data. As such, indirect estimation methods may be avoided, thereby providing more accurate control parameters for operation of the EESM. EESM performance and efficiency may be increased, as result, if desired.

Turning now to FIG. 2B, it shows an embodiment of a cross-section of an example of the transformer 262 in a rotor 263 of the EESM. The transformer 262 may be included in an inductive excitation system that includes a non-contact sensor. This inductive excitation system supplies power to the rotor of the EESM, as previously discussed.

The transformer 262 may include a first yoke 202 and a second yoke 212. The first yoke 202 and the second yoke 212 may be concentric with an axis 299. In one example, the axis 299 is an axis of rotation for a shaft and other rotating components of the electric motor. The first yoke 202 may rotate about the second yoke 212.

The first yoke 202 may be a rotating ferromagnetic core. The second yoke 212 may be a stationary ferromagnetic core. Thus, the yokes 202 and 212 may form a ferromagnetic core of the transformer 262. The first yoke 202 is spaced away from the second yoke 212 such that the first yoke 202 does not touch the second yoke 212. Thus, a gap 210 is present between the first yoke 202 and the second yoke 212.

In one example, the first yoke 202 includes a first portion 202A, a second portion 202B, and a third portion 202C. The first portion 202A may be the furthest from the axis 299 and the third portion 202C may be the closest to the axis 299.

In one example, the second yoke 212 includes a first portion 212A, a second portion 212B, and a third portion 212C. The first portion 212A may be the closest to the axis 299 and the third portion 212C may be the furthest from the axis 299. Each of the first, second, and third portions may include rectangular cross-sectional shapes. In one example, the first portion 212A of the second yoke 212 faces only the first portion 202A of the first yoke 202. The second portion 212B of the second yoke 212 faces each of the first portion 202A and the second portion 202B of the first yoke 202. The third portion 212C of the second yoke 212 faces each of the second and third portions 202B, 202C of the first yoke 202.

A first transformer coil 204 may be coupled to the first yoke 202. The first transformer coil 204 is physically coupled to each of the first portion 202A and the second portion 202B of the first yoke 202. The first transformer coil 204 may be configured to rotate with the first yoke 202. A second transformer coil 214 may be coupled to the second yoke 212. The second transformer coil 214 is physically coupled to each of the first portion 212A and the second portion 212B of the second yoke 212. The second transformer coil 214 may be stationary with the second yoke 212. In one example, the gap 210 may extend between the first transformer coil 204 and the second transformer coil 214. The first transformer coil 204 and the second transformer coil 214 may partially circumferentially overlap with one another without contacting each other.

Flux paths 291 and 292 illustrate the transformer's magnetic flux paths through the yokes of the transformer of the inductive excitation system. A first flux path 291 illustrated in a first half of the transformer 262 flows in a clockwise direction. A second flux path 292 illustrated in a second half of the transformer 262 flows in a counterclockwise direction. In one example, the first flux path 291 and the second flux path 292 are mirror-images of one another and include magnetic flux flowing in identical directions through the respective yokes.

A solenoid coil 206 may be coupled to the first yoke 202. The solenoid coil 206 may be spaced away from the first transformer coil 204. The solenoid coil 206 may face the gap 210A.

A first AC rotor current magnetic flux path 294 is shown in FIG. 2B in the first half of the transformer 262 and flows in a counterclockwise direction. A second AC rotor current magnetic flux path 295 is shown in the second half of the transformer 262 and flows in a clockwise direction. As such, the AC rotor current magnetic flux paths may flow in a direction opposite to the transformer magnetic flux paths.

A printed circuit board (PCB) 208 may be arranged adjacent to a portion of the first yoke 202 distal to the gap 210. The PCB 208 may include a rectifier such as the rectifier 272, shown in FIG. 2A. The PCB 208 may be arranged outboard the first yoke 202. The rectifier may be an active rectifier or a passive rectifier, as previously discussed.

A non-contact sensor 230 may be coupled to the third portion 212C of the second yoke 212. The sensor 230 may be a Hall-effect sensor. The sensor 230 is stationary and does not rotate or move. The sensor 230 may be configured to measure an DC flux 294 or 295. Output from the sensor 230 may be used to indirectly estimate a rotor current. In one example, the magnetic field generated by the DC rotor current, which flows through the solenoid coil 206, is sensed by the sensor 230 coupled to the stationary portion of the yoke. The sensor 230 may output a voltage proportional to the DC rotor current.

In some examples, additionally or alternatively, the solenoid coil 206 may not be coupled to the first yoke 202. The solenoid coil 206 may be coupled to an outer portion of the system or another location. In one example, the position of the solenoid coil 206 may be such that its flux passes through the sensor 230 on the stationary side of the ferromagnetic core.

The controller 182 of FIG. 1 may be electronically coupled to the sensor 230. The controller 182 may receive the voltage from the sensor 230 and adjust operating parameters of an electric machine comprising the transformer 262 based on the voltage output by the sensor 230. In this way, operation of the transformer 262, and therefore an electric machine, may be adjusted based on an output of a stationary sensor, such as the sensor 230. More detailed rotor control strategies in the EESM are expanded upon below.

In this way, a stationary, non-rotating Hall-effect current sensor is configured to sense the rotor current directly. The Hall-effect current sensor is mounted on the stationary ferromagnetic core of the transformer. A solenoid coil is added to the rotating ferromagnetic core of the transformer through which the EESM DC rotor current flows which is measured. The ferromagnetic core of the rotating transformer includes two functions, it acts as the ferromagnetic core of the rotating transformer and it concentrates the signal and shields the sensor for external stray fields. This proposed rotor architecture does not require brushes nor a wireless communication link, if desired.

An indirect rotor current estimation via a stationary, non-rotating current sensor can be done via measuring the AC in the stationary part of the rotating transformer or by measuring the input current of the DC to AC converter which supplies power to the stationary part of the rotating transformer, in one example.

In this way, a concept for an electric machine is proposed where rotor current is directly sensed via a stationary (i.e., non-rotating) hall-effect current sensor. The hall-effect current sensor is mounted on the stationary ferromagnetic core of the transformer and a solenoid coil is added to the rotating ferromagnetic core of the transformer through which the EESM DC rotor current flows which is measured. The ferromagnetic core of the rotating transformer thus has two functions: it acts as the ferromagnetic core of the rotating transformer and it concentrates the signal and shields the sensor for external stray fields.

Turning now to FIG. 3, it shows a high-level method 300 for adjusting an inverter (e.g., a DCAC converter or H-bridge) which supplies power to a stationary side of the rotating transformer. To elaborate, the output frequency supplied by the DCAC converter to the rotating transformed is adjusted in response to conditions of the EESM. Instructions for carrying out method 300 and the rest of the methods included herein may be executed by a controller based on instructions stored on a memory of the controller and in conjunction with signals received from sensors of the system (e.g., powertrain system), such as the sensors described above with reference to FIGS. 1-2B. The controller may employ actuators of the system to adjust operation, according to the methods described below.

The method 300 begins at 302, which includes determining operating parameters. Operating parameters that may be considered when adjusting the inverter output frequency may include at least, one or more of a rotor field winding current 304, a temperature of a static portion of the transformer 306, and a temperature of a rotating portion of the transformer 308. The rotor field winding current 304 may be measured via the stationary sensor 230 of FIG. 2A. The temperature of the static portion of the transformer 306 may be sensed via a first temperature sensor, such as a thermocouple. The temperature of the rotating portion of the transformer may be sensed via a second temperature sensor, such as a thermocouple. Additionally or alternatively, an optical fiber temperature sensor may be used to measure the static and/or rotating portions of the temperature sensor.

At 310, the method 300 includes determining a target switching frequency of an output of the inverter (e.g., the DCAC converter) based on the operating parameters. To elaborate, the switching frequency of the DCAC converter in the inverter is determined based on a signal from the hall-effect current sensor that is indicative of the field current of the rotor windings as well as the temperature of the rotating and stationary parts (e.g., yokes) of the transformer.

At 312, the method includes adjusting the inverter (e.g., DCAC converter) to generate an output with the target switching frequency that was determined at step 310. Thus, the DCAC converter transfers the output with the target switching frequency to the rotor windings by way of the transformer and the rectifier. Method 300 allows part load losses in the electric machine to be reduced or equivalently the efficiency to be increased and/or the peak performance to be increased (e.g., by having higher switching frequency the magnetizing current of the transformer is reduced and hence there are less losses in the stator). To elaborate, when the switching frequency is variable, at partial load, a lower rotor field current is used and hence a lower voltage on secondary transformer coil is sufficient, this opens the opportunity to reduce the switching frequency in order to reduce the frequency dependent losses. Additionally, since changing the frequency depending on the operating point will change the loss distribution between static and rotating part of the transformer, this strategy can also be leveraged to increase the peak current under given thermal constraints.

Turning now to FIG. 4, it shows a method 400 for operating an inverter. At 402, the method includes operating an inverter with an output at a lower switching frequency. For instance, a DCAC converter may be operated to output a signal with a lower switching frequency that is sent to the rotor coils by way of the transformer and the rectifier.

At 403, the method includes determining operating parameters. The operating parameters may include desired electric machine speed/torque, transformer temperature (e.g., stationary yoke and rotating yoke temperature), electric machine load, rotor field current, and the like. A use-case electric machine operational map, is shown in FIG. 6 and discussed in greater detail herein.

At 404, the method includes judging if a rapid torque step has been requested. For instance, it may be determined if the rate of change of the torque is greater than a threshold value (e.g., a non-zero positive value). For instance, if a sudden torque step is requested, a rapid increase in the rotor current may be desirable (e.g., <100 milliseconds (ms), in one use-case example). It will be understood that the electric machine may be operated according to an operating map that correlates torque, speed, and rotor current, which is discussed in greater detail herein with regard to FIG. 6.

As shown in FIG. 4, if it is judged that a rapid torque increase has not been requested (NO at 404) the method returns to 402. Conversely, if it is judged that a rapid torque increase has been requested (YES at 404) the method moves to 406.

At 406, the method includes operating the inverter to temporarily increase the switching frequency of the DCAC converter output. To expound, the DCAC converter may be temporarily operated with an output at a higher frequency to move the rotor current towards the set-point that corresponds to the requested increase in torque. The duration of the rotor current rise brought about by the increase in switching frequency may be much lower than the thermal time constant of the rotating transformer and of the DCAC converter and rectifier hence, although higher switching frequency gives higher losses, this can be sustained for a comparatively short period of time.

At 408, the method includes judging if a rotor current set-point has been achieved. If it is judged that the rotor current set-point has not been achieved (NO at 408) the method returns to 406. Conversely, if it is judged that the rotor current set-point has been achieved (YES at 408), the method moves to 410. At 410, the method includes operating the inverter (e.g., DCAC converter) with an output at a lower switching frequency. Method 400 allows the switching frequency output by the DCAC converter to be temporality increased to increase motor performance and then brought back down to a lower level that allows electric machine efficiency to be increased.

Turning now to FIG. 5, illustrating a timing diagram 500 for operating a DCAC converter in an inverter to rapidly reach a new rotor current set-point brought about by a rapid torque-step increase.

Plot 510 indicates requested torque vs time, plot 520 indicates switching frequency vs time, and plot 530 indicates rotor current vs time. Time increases from left to right in the frame of reference depicted in FIG. 5. Additionally, the requested torque, switching frequency, and rotor current increase from bottom to top, in the frame of reference depicted in FIG. 5. Prior to t1, the torque request is at a lower value and at t1, the torque request steps up to a higher value. Therefore, at t1, the rotor current set-point 532 is correspondingly increased.

Responsive to the torque request rapidly stepping up (e.g., surpassing a threshold value 533), the switching frequency of the output generated by the DCAC converter is temporarily increased until the rotor current 530 reaches the new set-point 532. Subsequent to t2, the switching frequency is reduced. In this way, electric machine operating efficiency is increased. To elaborate, the peak (e.g., maximum) voltage that is applied to the rotor winding determines how fast the rotor current can be changed. This peak voltage depends on the used switching frequency, the higher the switching frequency, the higher the induced voltage for a given maximum saturation flux density level of the ferromagnetic core. If a sudden torque step is requested, the rotor current needs to increase very fast (e.g., <100 milliseconds (ms), in one use-case example). By increasing the switching frequency generated by the DCAC converter during this short duration, more voltage can be applied and the rotor current can rise faster to its set-point. This current rise duration is typically much lower than the thermal time constant of the rotating transformer and of the DCAC converter and rectifier hence, although higher switching frequency gives higher losses, this can be sustained for a short period of time.

FIG. 6 shows an exemplary use-case map 600 for operating an electric machine and inverter specifically. The map 600 correlates motor torque, motor speed, and rotor winding field current. On each of the axes no specific numerical values are given but the plotted values linearly increase as depicted. It will be appreciated that any of the aforementioned EESMs or combinations of the EESM may be operated according to map 600, although a variety of suitable control strategies have been contemplated.

FIG. 7 shows a graph 700 that depicts a frequency spectrum of a signal that is generated by a DCAC converter and transferred to a transformer, in any of the previously described rotor systems or combinations of the rotor systems. To elaborate, the graph 700 shows amplitude vs frequency for a switching frequency sent to the transformer where jitters are applied to the switching frequency. Although specific values are not depicted in the graphs, frequency increases from left to right and amplitude increases from bottom to top. As shown, the peak of the frequency spectrum is relatively flat as indicated at 702. However, it will be understood that the frequency spectrum may have a sharper peak when jitters are not applied to the signal. By adding random jitter to the frequency of the DCAC converter the peaks in the radiated and emitted electromagnetic interference (EMI) power spectrum can be flattened out (as indicated at 702), typically devices in the neighborhood of the EMI source may be susceptible to a particular frequency in the power spectrum, by flattening out these peaks the chance of potential interference issues is reduced (e.g., avoided altogether).

FIG. 8 shows a graph 800 that depicts higher order harmonics applied to a pulse width modulation (PWM) signal generated by a DCAC converter and transferred through the transformer to the active rectifier, in any of the previously described rotor systems or combinations of the rotor systems. To elaborate, the graph 800 shows amplitude vs frequency. Although specific values are not depicted in the graphs, frequency increases from left to right and amplitude increases from bottom to top. The main frequency used for the main power transfer is indicated at 802 and the higher order harmonic that can be used for communication with the active rectifier is indicated at 804. In this way, the use of the active rectifier allows to superimpose a signal to the fundamental power transfer (e.g., by adapting the PWM modulation a higher order harmonic can be added which can be transferred via the rotating transformer to the stationary side where a filter can be used for demodulation of the encoded signal). Consequently, motor performance can be increased.

The disclosure also provides support for an externally excited electric machine, comprising: a sensor mounted on a stationary ferromagnetic core of a transformer, and a solenoid coil coupled to a rotating ferromagnetic core of the transformer. In a first example of the system, a printed circuit board is positioned on an outboard side of the rotating ferromagnetic core. In a second example of the system, optionally including the first example, the printed circuit board comprises a rectifier. In a third example of the system, optionally including one or both of the first and second examples, a first transformer coil is coupled to the rotating ferromagnetic core and a second transformer coil is coupled to the stationary ferromagnetic core. In a fourth example of the system, optionally including one or more or each of the first through third examples, the sensor is stationary. In a fifth example of the system, optionally including one or more or each of the first through fourth examples, the sensor is a Hall-effect current sensor. In a sixth example of the system, optionally including one or more or each of the first through fifth examples, a gap is arranged between the rotating ferromagnetic core and the stationary ferromagnetic core.

The disclosure also provides support for a transformer of an externally excited electric machine, comprising: a first yoke configured to rotate about an axis, a second yoke spaced away from the first yoke, wherein the second yoke is stationary, a solenoid coil coupled to the first yoke, and a Hall-effect sensor coupled to the second yoke. In a first example of the system, the Hall-effect sensor is configured to output a voltage proportional to a rotor current. In a second example of the system, optionally including the first example, a printed circuit board comprising a rectifier is coupled to an outer region of the first yoke. In a third example of the system, optionally including one or both of the first and second examples, the Hall-effect sensor is stationary. In a fourth example of the system, optionally including one or more or each of the first through third examples, the first yoke is a rotating ferromagnetic core and the second yoke is a stationary ferromagnetic core. In a fifth example of the system, optionally including one or more or each of the first through fourth examples, the first yoke is configured to concentrate a current signal toward the Hall-effect sensor. In a sixth example of the system, optionally including one or more or each of the first through fifth examples, the first yoke is configured to shield the Hall-effect sensor from external stray fields. In a seventh example of the system, optionally including one or more or each of the first through sixth examples, the solenoid coil and the Hall-effect sensor face a gap between the first yoke and the second yoke.

The disclosure also provides support for an externally excited electric machine, comprising: a sensor mounted on a stationary ferromagnetic core of a transformer, and a solenoid coil coupled to a rotating ferromagnetic core of the transformer, wherein the solenoid coil and the sensor face a gap between the stationary ferromagnetic core and the rotating ferromagnetic core. In a first example of the system, the rotating ferromagnetic core is configured to concentrate a current signal toward the Hall-effect sensor. In a second example of the system, optionally including the first example, the rotating ferromagnetic core configured to shield the Hall-effect sensor from external stray fields. In a third example of the system, optionally including one or both of the first and second examples, the sensor is stationary and fixedly coupled to the stationary ferromagnetic core. In a fourth example of the system, optionally including one or more or each of the first through third examples, the gap completely separates the stationary ferromagnetic core from the rotating ferromagnetic core.

The disclosure also provides support for an externally excited electric machine, comprising: a sensor mounted on a stationary ferromagnetic core of a transformer, a solenoid coil coupled to a rotating ferromagnetic core of the transformer, and a controller with instructions stored on non-transitory memory thereof that when executed enable the controller to adjust a frequency of an inverter based on feedback from the sensor. In a first example of the system, the sensor is configured to measure a current. In a second example of the system, optionally including the first example, the frequency of the inverter is further adjusted based on a temperature of the stationary ferromagnetic core of the transformer. In a third example of the system, optionally including one or both of the first and second examples, the frequency of the inverter is further adjusted based on a temperature of the rotating ferromagnetic core of the transformer. In a fourth example of the system, optionally including one or more or each of the first through third examples, the sensor is a stationary Hall-effect current sensor.

The disclosure also provides support for a method for a transformer of an externally excited electric machine comprising a sensor mounted to a stationary portion of the transformer, the method comprising: adjusting a frequency of an inverter from a frequency less than a lower threshold frequency to a frequency greater than an upper threshold frequency in response to a load of the electric machine increasing. In a first example of the method, the upper threshold frequency is greater than the lower threshold frequency, and wherein the upper threshold frequency is equal to a frequency used to operate the electric machine at a requested load. In a second example of the method, optionally including the first example, the method further comprises: operating the electric machine at a load less than a threshold load when the frequency of the inverter is less than the lower threshold frequency. In a third example of the method, optionally including one or both of the first and second examples, the frequency is greater than the upper threshold frequency for a threshold duration during a switching period. In a fourth example of the method, optionally including one or more or each of the first through third examples, the method further comprises: adjusting the frequency of the inverter based on feedback from the sensor. In a fifth example of the method, optionally including one or more or each of the first through fourth examples, the method further comprises: adjusting the frequency of the inverter based on a temperature of the stationary portion of the transformer and a temperature of a rotating portion of the transformer. In a sixth example of the method, optionally including one or more or each of the first through fifth examples, the method further comprises: adding jitter to the frequency of the inverter. In a seventh example of the method, optionally including one or more or each of the first through sixth examples, the method further comprises: directly communicating between the rotor and a controller, wherein the controller comprises instructions stored on non-transitory memory that when executed enable the controller to execute the method. In an eighth example of the method, optionally including one or more or each of the first through seventh examples, the frequency is adjusted based on a current sensed by the sensor. In a ninth example of the method, optionally including one or more or each of the first through eighth examples, the sensor is stationary

The disclosure also provides support for a method for an externally excited electric machine comprising a sensor mounted on a stationary ferromagnetic core of a transformer and a solenoid coil coupled to a rotating ferromagnetic core of the transformer, wherein the solenoid coil and the sensor face a gap between the stationary ferromagnetic core and the rotating ferromagnetic core, the method, comprising: in response to a requested load of the electric machine changing from a load less than a threshold load to a load greater than the threshold load, increasing a frequency of an inverter from a frequency less than a lower threshold frequency to a frequency greater than an upper threshold frequency during a switching period, and in response to the requested load of the electric machine changing from a load greater than the threshold load to a different load greater than the threshold load, changing the frequency of the inverter from a frequency greater than the lower threshold frequency and less than the upper threshold frequency to a different frequency greater than the lower threshold frequency and less than the upper threshold frequency. In a first example of the method, the upper threshold frequency is equal to a frequency of the inverter used to operate the electric machine at the requested load following the switching period. In a second example of the method, optionally including the first example, the frequency is greater than the upper threshold frequency for a threshold duration. In a third example of the method, optionally including one or both of the first and second examples, the threshold duration is less than a thermal time constant of the rotating ferromagnetic core. In a fourth example of the method, optionally including one or more or each of the first through third examples, the method further comprises: operating the inverter with a frequency less than the lower threshold frequency in response to the load of the electric machine being less than the threshold load.

As used herein, the term “approximately” is construed to mean plus or minus five percent of the range unless otherwise specified.

The following claims particularly point out certain combinations and sub-combinations regarded as novel and non-obvious. These claims may refer to “an” element or “a first” element or the equivalent thereof. Such claims should be understood to include incorporation of one or more such elements, neither requiring nor excluding two or more such elements. Other combinations and sub-combinations of the disclosed features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

1. An externally excited electric machine, comprising:
a non-contact sensor mounted on a stationary ferromagnetic core of a transformer;
a solenoid coil coupled to a rotating ferromagnetic core of the transformer; and
a controller with instructions stored on non-transitory memory thereof that when executed enable the controller to adjust a switching frequency of an inverter based on feedback from the sensor.

2. The electric machine of claim 1, wherein the non-contact sensor is configured to measure a current.

3. The electric machine of claim 2, wherein the switching frequency of the inverter is further adjusted based on a temperature of the stationary ferromagnetic core of the transformer.

4. The electric machine of claim 1, wherein the switching frequency of the inverter is further adjusted based on a temperature of the rotating ferromagnetic core of the transformer.

5. The electric machine of claim 1, wherein the sensor is a stationary Hall-effect current sensor.

6. A method for a transformer of an externally excited electric machine comprising a sensor mounted to a stationary portion of the transformer, the method comprising:
actively adjusting a switching frequency of a direct current (DC) to alternating current (AC) converter based on changes electric machine load.

7. The method of claim 6, wherein the upper threshold frequency is greater than the lower threshold frequency, and wherein the upper threshold frequency is equal to a frequency used to operate the electric machine at a requested load.

8. The method of claim 6, further comprising operating the electric machine at a load less than a threshold load when the frequency of the inverter is less than the lower threshold frequency.

9. The method of claim 6, wherein the frequency is greater than the upper threshold frequency for a threshold duration during a switching period.

10. The method of claim 6, further comprising adjusting the frequency of the inverter based on feedback from the sensor.

11. The method of claim 10, further comprising adjusting the frequency of the inverter based on a temperature of the stationary portion of the transformer and a temperature of a rotating portion of the transformer.

12. The method of claim 6, further comprising adding jitter to the frequency of the inverter.

13. The method of claim 6, further comprising directly communicating between a rotor of the electric machine and a controller, wherein the controller comprises instructions stored on non-transitory memory that when executed enable the controller to execute the method.

14. The method of claim 6, wherein the frequency is adjusted based on a current sensed by the sensor.

15. The method of claim 6, wherein the sensor is stationary.

16. A method for an externally excited electric machine, comprising:
in response to a requested load of the electric machine changing from a load less than a threshold load to a load greater than the threshold load, increasing a frequency of an inverter from a frequency less than a lower threshold frequency to a frequency greater than an upper threshold frequency during a switching period; and
in response to the requested load of the electric machine changing from a load greater than the threshold load to a different load greater than the threshold load, changing the frequency of the inverter from a frequency greater than the lower threshold frequency and less than the upper threshold frequency to a different frequency greater than the lower threshold frequency and less than the upper threshold frequency;
wherein the externally excited electric machine comprises:
a non-contact sensor mounted on a stationary ferromagnetic core of a transformer and a solenoid coil coupled to a rotating ferromagnetic core of the transformer, wherein the solenoid coil and the sensor face a gap between the stationary ferromagnetic core and the rotating ferromagnetic core.

17. The method of claim 16, wherein the upper threshold frequency is equal to a frequency of the inverter used to operate the electric machine at the requested load following the switching period.

18. The method of claim 16, wherein the frequency is greater than the upper threshold frequency for a threshold duration.

19. The method of claim 18, wherein the threshold duration is less than a thermal time constant of the rotating ferromagnetic core.

20. The method of claim 16, further comprising operating the inverter with a frequency less than the lower threshold frequency in response to the load of the electric machine being less than the threshold load.
